(19) United States
(12) Patent Application Publication
(10) Pub. No.: US 2019/0232298 A1
(43) Pub. Date: Aug. 1, 2019

(54) MECHANISM FOR PREVENTION OF ROTATION OF BOWL LINER WITH RESPECT TO BOWL OF CONE CRUSHER

(71) Applicant: Johnson Crushers International, Inc., Eugene, OR (US)

(72) Inventor: Jon Juhlin, Lowell, OR (US)

(73) Assignee: Johnson Crushers International, Inc., Eugene, OR (US)

(21) Appl. No.: 16/259,415

(22) Filed: Jan. 28, 2019

Related U.S. Application Data
(60) Provisional application No. 62/624,356, filed on Jan. 31, 2018.

(51) Int. Cl. B02C 2/04; B02C 2/00

(52) U.S. Cl. CPC B02C 2/045; B02C 2/005

(57) ABSTRACT

A cone crusher apparatus having a bowl liner removably mounted within a bowl. A wedge is radially adjustable between an inside surface of the bowl and an outside surface of the bowl liner. The wedge moves radially between a rotation-preventing position and a rotation-permitting position. In the rotation-preventing position, the wedge is in simultaneous abutment with the bowl and bowl liner and through that simultaneous abutment immediately develops a maximum holding force such that relative motion between the bowl liner and bowl in a first rotational direction is prevented. In the rotation-permitting position, the wedge is not in simultaneous abutment with the bowl and bowl liner and at least some relative motion between the bowl liner and bowl in the first rotational direction is permitted.

### CROSS-REFERENCE TO RELATED APPLICATIONS

This application claims the benefit of U.S. Provisional Patent Application No. 62/624,356, filed on Jan. 31, 2018 and entitled MECHANISM FOR PREVENTION OF ROTATION OF BOWL LINER WITH RESPECT TO BOWL OF CONE CRUSHER, which is incorporated herein by reference in its entirety.

### FIELD OF THE INVENTION

This invention relates generally to gyratory cone crushers, and more particularly, to a system for retaining the bowl liner against rotational movement during operation of the crusher.

### BACKGROUND OF THE INVENTION

A gyratory cone crusher is suitable for crushing a variety of types of rock. It has the advantage of reliable construction, high productivity, easy adjustment and low operational costs. It operates by squeezing the rock between an eccentrically gyrating cone, which is covered by a wear-resistant mantle, and an enclosing concave bowl, which is covered by a stationary wear-resistant manganese bowl liner. As rock enters the top of the crusher, it becomes wedged and squeezed between the mantle and the bowl liner. Large pieces of rock are broken once, and then fall to a lower position (because they are now smaller) where they are broken again as the cone gyrates about the central axis of the bowl. This process continues until the pieces are small enough to fall through the narrow opening between the lower portions of the mantle and bowl liner. Both the mantle and the bowl liner are subject to wear as the crusher is operated, and both have to be replaced from time to time. The bowl of a gyratory cone crusher is typically supported by a bowl support. The bowl support is attached to the frame of the machine and is adapted to be raised and lowered with respect to the bowl liner in order to enlarge or reduce the opening between the mantle and the bowl liner.

The bowl liner must be retained within the bowl so that it can withstand the forces and impacts that are encountered during the crushing operation. Because the cone and mantle rotate as material is crushed between the mantle and the stationary bowl liner, the bowl liner is subjected to tangential or rotational forces exerted by the crushing action as the compressive load moves around the surface of the bowl liner. These tangential forces tend to cause the bowl liner to rotate within the bowl if the tangential load is high enough to overcome the frictional resistance resulting from the clamping load.

It is known to provide a mechanism to allow the bowl liner to self-tighten when rotation occurs by increasing the friction until rotation is arrested. Some of these conventional self-tightening mechanisms employ wedges that extend between the bowl and the bowl liner. For example, one such self-tightening mechanism is disclosed by U.S. Pat. No. 3,235,190, entitled “Bowl Liner for Gyratory Crusher” (the '190 Patent). In some cases, the upward thrust to hold the bowl liner in contact with the bowl is provided by an engaging flange or hook on the liner that moves circumferentially up the wedge until sufficient friction is developed to arrest further rotation. Other systems rely on engagement between the top surface of the wedge and a convoluted edge that is formed into the lower surface of a flange that extends around the entire circumference of the top opening of the bowl liner. Both of these systems require some degree of rotational movement by the bowl liner with respect to the bowl to achieve their full holding force. However, it is sometimes desirable to have a system that does not require rotation to achieve full holding force.

It is also known to provide systems that are not self-tightening. These known systems rely on interlocking components on the bowl and bowl liner that act to clamp the bowl liner securely to the bowl. One example of such a mechanism disclosed by U.S. Pat. No. 7,229,040, entitled “Bowl Liner Retaining Method and Apparatus” (the '040 Patent). An example of an apparatus described by the '040 Patent is illustrated in FIGS. 1 and 2. Referring first to FIG. 1, there is provided a conventional gyratory cone crusher 10 having a bowl 12 having an inside surface 70 formed by a lower portion 64A (which is sometimes at least partially conical in shape), a horizontal middle portion 64B, and a vertical upper portion 64C. The bowl 12 is in threaded engagement with bowl support portion 14 of machine frame 16. Bowl 12 is inverted over cone assembly 18 and is centered on vertical crusher axis 20. Bowl 12 provides structural support for replaceable bowl liner 22, and cone assembly 18 includes replaceable mantle 24. The bowl liner 22 and the mantle 24 cooperate to define a crushing chamber through which material entering the top of crusher 10 must pass as the cone assembly gyrates about axis 20. During the crushing operation, this material is subjected to compression crushing forces between bowl liner 22 and mantle 24.

Since cone assembly 18 gyrates and crushes material between mantle 24 of the gyrating cone assembly and stationary bowl liner 22, tangential or rotational forces are applied to the bowl liner with respect to bowl 12 and may cause rotation. Certain portions of an outside surface 66 of the bowl liner 22 and the lower portion 64A of the inside surface 70 of the bowl 12 may be substantially adjacent and interlock with one another. This geometry assists in connecting the bowl liner 22 and bowl 12 together to prevent rotation. In this particular case, rotation is prevented by providing ears or bosses 60 in the outside surface 66 of the bowl liner 22 that are configured to engage corresponding detents or slots 62 that are formed in the conical lower portion 64A of the inside surface 70 of the bowl 12, such that rotation of the bowl liner within the bowl is resisted. Often, an epoxy 68 is deposited into and fills a space located between conical lower portion 64A of the inside surface 70 of the bowl 12 and the outside surface 66 of the bowl liner 22. However, some in cases, it may be desirable to have a bowl inside surface 64A and bowl liner outside surface 66 that are smooth and flat (i.e. without bosses 60 or slots 62) or clean (i.e., without epoxy 68) or both, while still preventing rotation of the bowl liner 22 with respect to the bowl 12.

### Notes on Construction

The use of the terms “a”, “an”, “the” and similar terms in the context of describing embodiments of the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of embodiments of the invention is not intended to limit such characteristic to the absolute value which the term modifies, but rather to provide an approximation of the value of such physical or functional characteristic.

Terms concerning attachments, coupling and the like, such as “attached”, “connected” and “interconnected”, refer to a relationship wherein structures are secured or attached to one another either directly or indirectly through intervening structures, as well as both moveable and rigid attachments or relationships, unless otherwise specified herein or clearly indicated as having a different relationship by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate preferred embodiments of the invention, and not to place a limitation on the scope of the invention. Nothing in the specification should be construed as indicating any element as essential to the practice of the invention unless so stated with specificity.

The terms “inner”, “inside” and similar terms, when used in reference to a relative position or direction on or with respect to a gyratory cone crusher, or a component or portion of such a crusher, refer to a relative position or direction that is towards axis 20.

The terms “outer”, “outside” and similar terms, when used in reference to a relative position or direction on or with respect to a gyratory cone crusher, or a component or portion of such a crusher, refer to a relative position or direction that is away from axis 20.

The term “upwardly extending”, when used in reference to components of a gyratory cone crusher, including wedges, lugs, spacers as well as interfaces between those various components, refers only to the orientation of those surfaces and interfaces and does not relate to their shape. The term “upwardly extending” means extending in a direction that is generally parallel with axis 20. As a non-limiting example, the term “upwardly extending” includes planar vertical surfaces as well as contoured, curved, angled surfaces or shapes that are oriented in a direction that is generally parallel with axis 20.

### SUMMARY OF THE INVENTION

The above and other needs are met by a cone crusher apparatus having a bowl with an inside surface, a bowl liner having an outside surface and being removably mounted within the bowl along a central axis passing through the bowl and bowl liner such that the outside surface of the bowl liner is substantially adjacent the inside surface of the bowl, and a wedge that is radially adjustable between the inside surface of the bowl and the outside surface of the bowl liner for moving between a rotation-preventing position and a rotation-permitting position. In the rotation-preventing position, the wedge is in simultaneous abutment with the bowl and bowl liner and through that simultaneous abutment immediately develops a maximum holding force such that relative motion between the bowl liner and bowl in a first rotational direction about the central axis is prevented. In the rotation-permitting position, the wedge is not in simultaneous abutment with the bowl and bowl liner and at least some relative motion between the bowl liner and bowl in the first rotational direction about the central axis is permitted.

In some embodiments, when the wedge is in the rotation-preventing position, the bowl liner is in abutment with the wedge along a first upwardly extending liner-wedge interface and the bowl is in abutment with the wedge along a first upwardly extending bowl-wedge interface such that the wedge is sandwiched between the bowl and bowl liner. In certain preferred embodiments, a bowl liner protrusion extends radially outwards from the outside surface of the bowl liner. The bowl liner protrusion and the first upwardly extending liner-wedge interface is created when the bowl liner protrusion abuts the wedge. In other preferred embodiments, a bowl protrusion extends radially inwards from the inside surface of the bowl and the first upwardly extending bowl-wedge interface is created when the bowl protrusion abuts the wedge.

In certain embodiments, the wedge is configured to be radially positioned such that, with relative motion between the bowl liner and bowl in a second rotational direction about the central axis, the bowl liner abuts the wedge along a second upwardly extending liner-wedge interface and the bowl abuts a the wedge along a second upwardly extending bowl-wedge interface, such that the wedge is sandwiched between the bowl and bowl liner and prevents further relative motion between the bowl liner and bowl in the second rotational direction about the central axis. In certain preferred embodiments, a bowl liner protrusion extends radially outwards from the outside surface of the bowl liner and the first upwardly extending liner-wedge interface is created when the bowl liner protrusion abuts the wedge and the second upwardly extending liner-wedge interface is created when the bowl liner protrusion abuts the wedge.

In certain preferred embodiments, a bowl protrusion extends radially inwards from the inside surface of the bowl. The first upwardly extending bowl-wedge interface is created when the bowl protrusion abuts the wedge to prevent relative motion between the bowl liner and bowl in the first rotational direction about the central axis. The second upwardly extending bowl-wedge interface is created when the bowl protrusion abuts the wedge to prevent relative motion between the bowl liner and bowl in the second rotational direction about the central axis. In additional preferred embodiments, a gap area is defined by a pair of spaced apart upwardly extending surfaces formed by the bowl protrusion and that extend upwards from the inside surface of the bowl. The wedge is located within the gap area and travels over the inside surface of the bowl when moving radially between the inside surface of the bowl and the outside surface of the bowl liner. In certain embodiments, the wedge includes a first wedge for forming the first upwardly extending liner-wedge interface and the first upwardly extending bowl-wedge interface and a second wedge that is separate and independently radially adjustable from the first wedge for forming the second upwardly extending liner-wedge interface and the second upwardly extending bowl-wedge interface.

Certain embodiments of the invention include a retention ring surrounding a top end of the bowl liner and located above the wedge. Additionally, a plurality of fasteners that pass through the retention ring in a direction parallel with the central axis, including at least one fastener that exerts a force downwards onto the wedge. In certain preferred embodiments, one or more retention ring supports are located radially outside the retention ring and have a radially-oriented fastener for exerting a radial force on the retention ring.

Lastly, in certain embodiments, the wedge is radially moved between the rotation-preventing position and rotation-permitting position by a hydraulic linear actuator.

### BRIEF DESCRIPTION OF THE DRAWINGS

The presently preferred embodiments of the invention are illustrated in the accompanying drawings, in which like reference numerals represent like parts throughout, and in which:

FIG. 1 is a cross-sectional view of a conventional gyratory cone crusher;

FIG. 2 is a cross-sectional view detailing section “A” of FIG. 1;

FIG. 3 is a cross-sectional view of a gyratory cone crusher according to an embodiment of the present invention;

FIG. 4 is a cross-sectional view detailing section “B” of FIG. 3;

FIG. 5 is a plan view depicting a portion of a gyratory cone crusher in a rotation-preventing position according to an embodiment of the present invention;

FIG. 6 is a top perspective view of a bowl liner including a plurality of wedges and lugs used in a gyratory cone crusher according to an embodiment of the present invention;

FIG. 7 is a top perspective view of a bowl used in a gyratory cone crusher according to an embodiment of the present invention;

FIG. 8 is top perspective view of portions of the bowl liner of FIG. 6 and the bowl of FIG. 7 illustrating how these components are assembled together;

FIG. 9 is a top perspective view of the bowl liner of FIG. 6 and the bowl of FIG. 7;

FIG. 10 is a top perspective view of a portion of the bowl liner of FIG. 6 and the bowl of FIG. 7, showing how the wedges engage portions of the bowl;

FIG. 11 is a sectional view of a portion of the bowl liner of FIG. 6 and the bowl of FIG. 7 taken between adjacent wedges;

FIG. 12 is a sectional view of a portion of the bowl liner of FIG. 6 and the bowl of FIG. 7 taken through a wedge; and

FIG. 13 is a plan view depicting a portion of a gyratory cone crusher in a rotation-preventing position according to an alternative embodiment of the present invention.

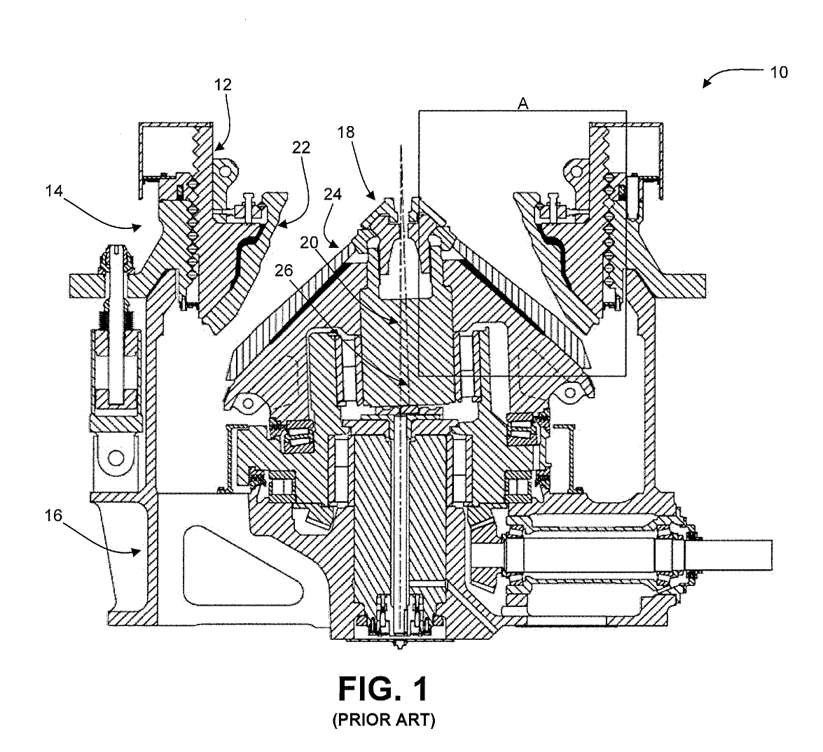

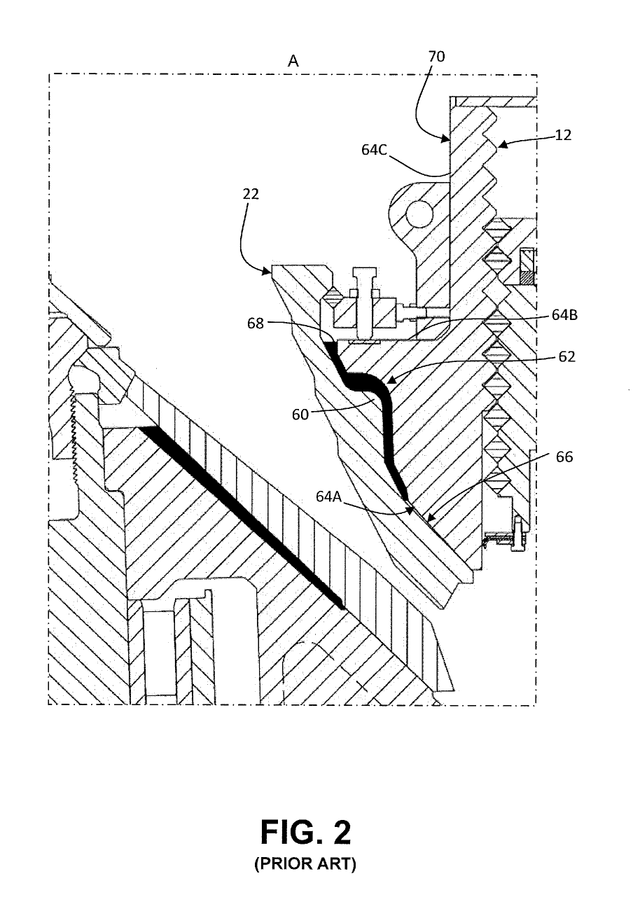

### DESCRIPTION OF THE PREFERRED EMBODIMENTS OF THE INVENTION

This description of the preferred embodiments of the invention is intended to be read in connection with the accompanying drawings, which are to be considered part of the entire written description of this invention. The drawings are not necessarily to scale, and certain features of embodiments of the invention may be shown exaggerated in scale or in somewhat schematic form in the interest of clarity and conciseness.

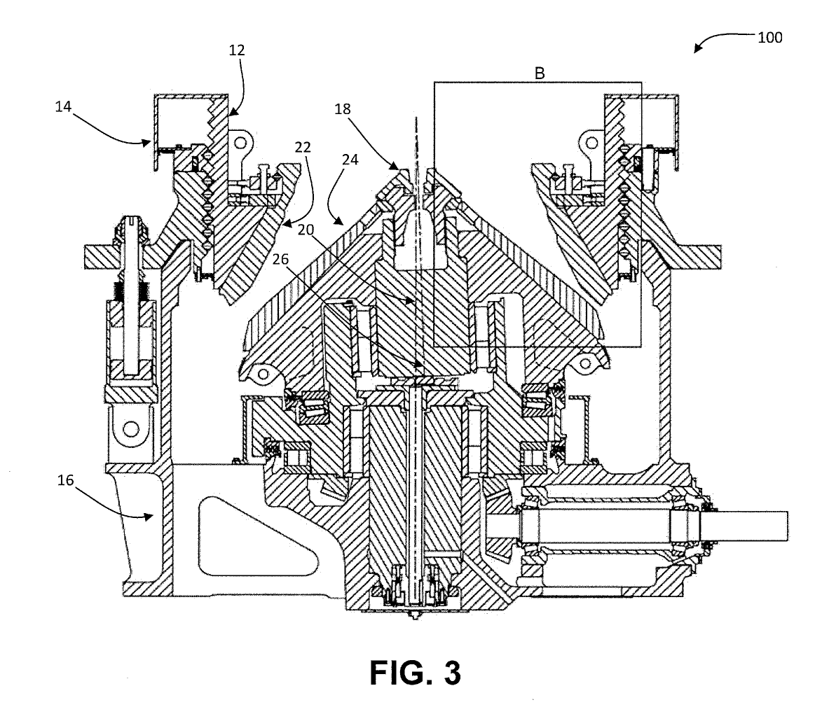

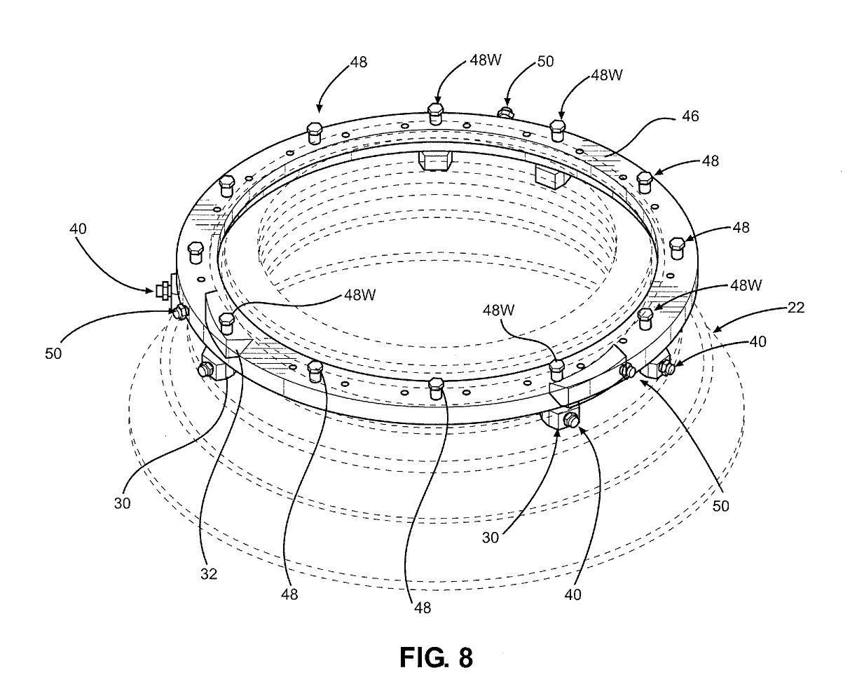

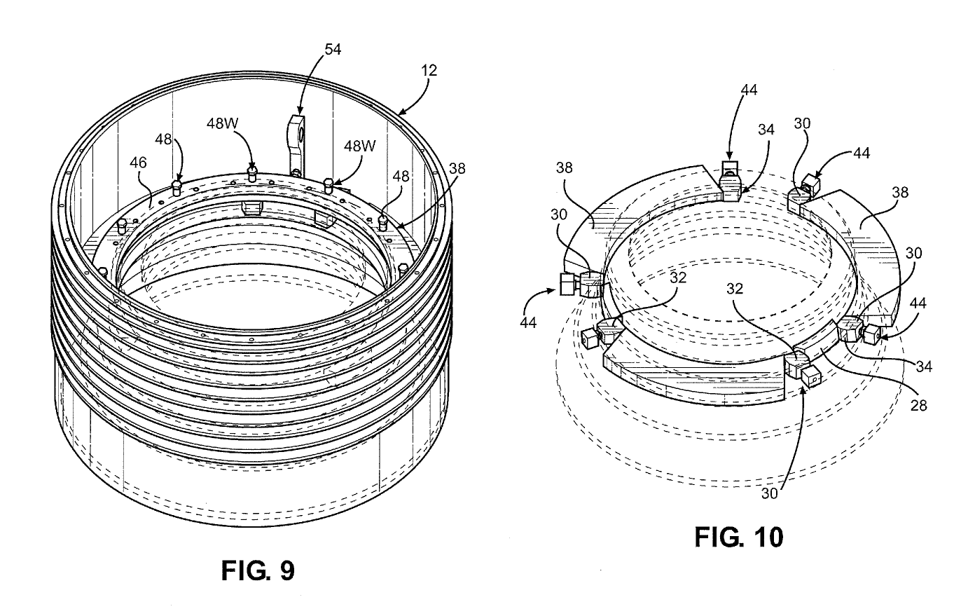

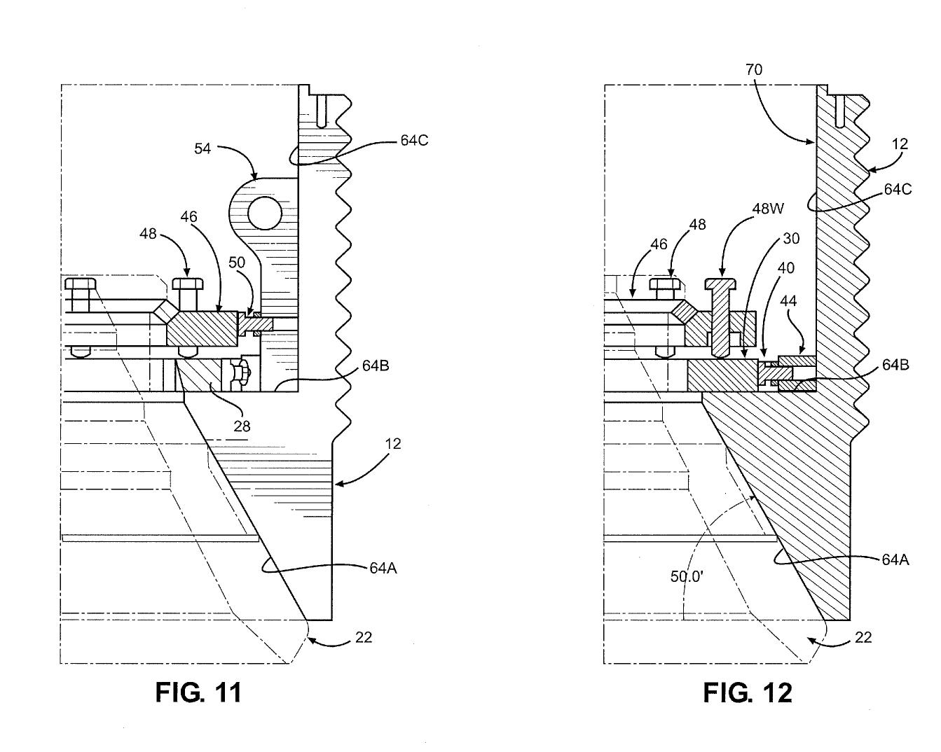

With reference now to FIGS. 3-12, there is provided a gyratory cone crusher system 100 for securely attaching a bowl liner 22 to a bowl 12 and that resists rotational forces that tend to cause the bowl liner to rotate with respect to the bowl according to an embodiment of the present invention. The system 100 includes a bowl liner 22 with at least one bowl liner protrusion or lug 28, and preferably more than one lug, each of which is disposed on and may be integrally formed in (e.g., cast) or otherwise affixed to the outer surface 66 of the bowl liner. Unlike the ears 60 taught by conventional systems discussed previously, the lugs 28 are not formed opposite the conical lower portion 64A of the bowl 12. Instead, as will become apparent below, the lugs 28 are located along an upper portion of the outside surface 66 of the bowl liner 22 adjacent the horizontal middle portion 64B of the inside surface 70 of the bowl 12.

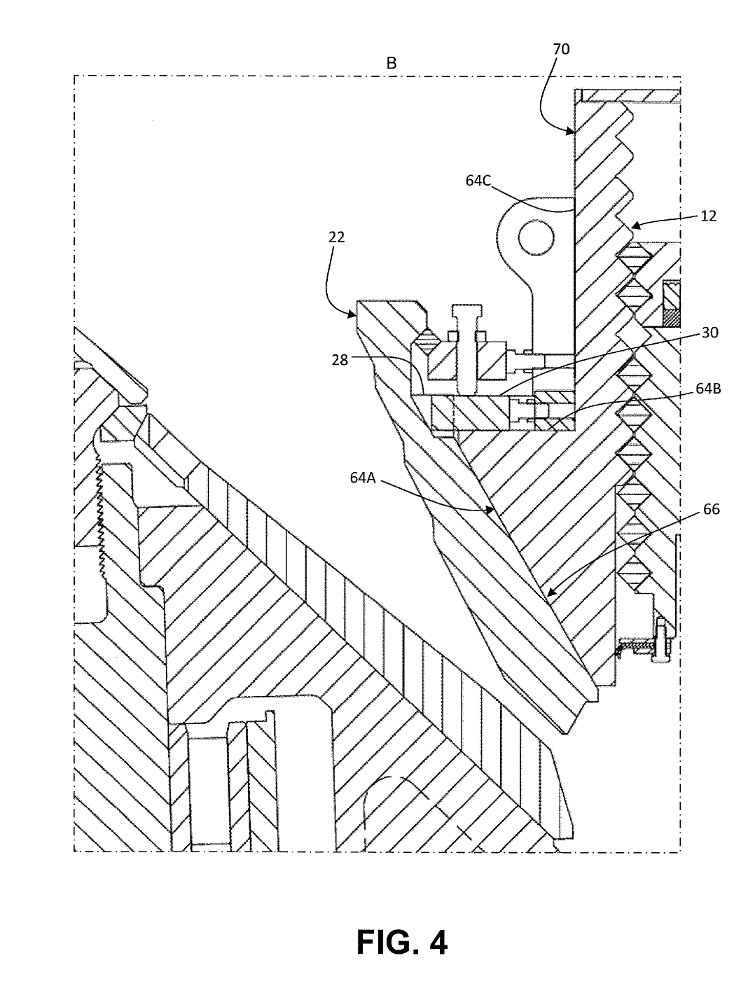

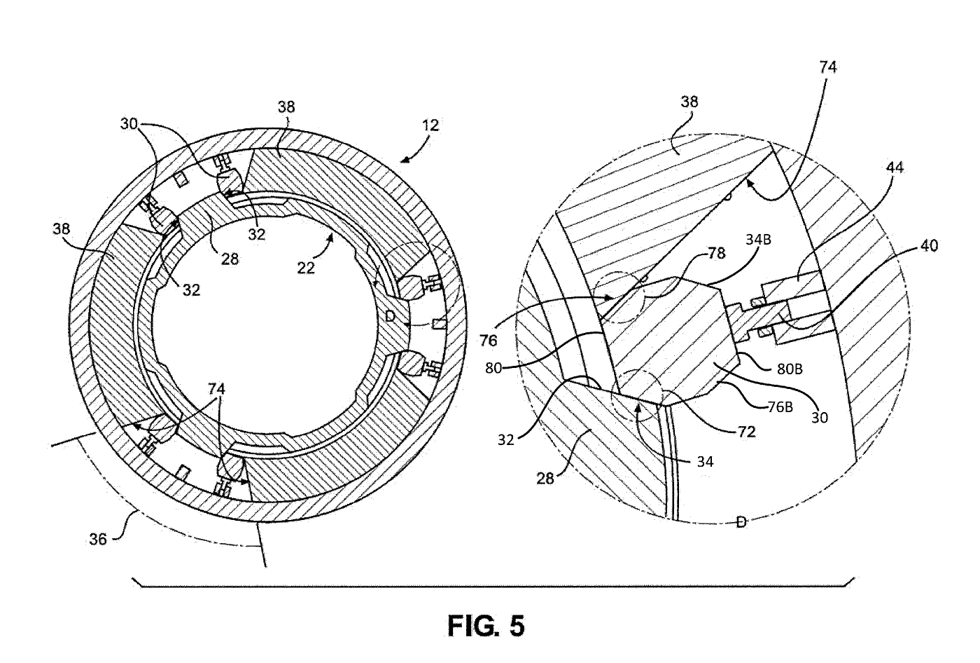

As shown best in FIGS. 4 and 5, a wedge 30 and, more preferably, a pair of wedges is placed on the horizontal middle portion 64B of the inside surface 70 of the bowl 12. Each pair of wedges 30 is adapted to fit within a gap area 36 defined by bowl protrusions (or spacers 38) that are located along the inside surface 70 of bowl 12. The wedges 30 are configured to slide over the horizontal middle portion 64B of the inside surface 70 of the bowl 12, guided by the spacers 38, inwards towards and outwards away from the bowl liner 22 (i.e. radially towards axis 20 shown in FIG. 3) and lug 28. The wedges 30 are configured to slide between (i) a rotation-preventing position, where relative rotational motion between the bowl 12 and bowl liner 22 is prevented, and (ii) a rotation-permitting position, where relative rotational motion between the bowl and bowl liner is permitted.

The lugs 28 include upwardly extending surfaces 32 that are adapted to abut corresponding upwardly extending surfaces 34 in each of the wedges 30 at an upwardly extending liner-wedge interface 72 when the wedge is in the rotation-preventing position. The spacers 38 also preferably have an upwardly extending surface 74 that abuts with a corresponding upwardly extending surface 76 of the wedges at an upwardly extending bowl-wedge interface 78 in the rotation-preventing position. In this particular illustrated embodiment, surfaces 32, 34, 74, and 76 and interfaces 72 and 78 are not only upwardly-extending but are also planar and vertical. However, in other embodiments, surfaces 32, 34, 74, and 76 and interfaces 72, 78 are upwardly extending at some other non-vertical angle or configuration (e.g., curved). Preferably, each surface 34, 76 of the wedges is angled inwards (when viewed from a top-down perspective, as shown best in the detail portion of FIG. 5) to accommodate a close approximation with corresponding surfaces 32, 74 of the lug 28 and spacer 38, respectively. Also preferably, the wedges 30 are configured for use in at least two orientations (i.e., reversible). In those cases, each of the wedges has a leading end 80A that is located between adjacent surface 34 and 76 that could be placed into use, as discussed above. In addition, each of the wedges would include a trailing end 80B that is located opposite leading end 80A and that is located between adjacent surface 34B and 76B that may also be placed into use in the same manner as discussed above. The advantage of a reversible wedge 30 is that, if one side of the wedge 30 becomes worn or damaged, the opposite side could be placed into use, thereby extending the useful life of the wedge. Another advantage of a reversible wedge 30 is it could be more easily and more quickly placed into operation. In other embodiments, the wedge 30 could be orientated in any orientation. In that case, for example, the octagonal wedge shown in FIG. 5 could be used in eight different orientations, which would significantly simplify installation of the wedge.

Preferably, in the rotation-preventing position, the wedge 30 is in simultaneous abutment with both (i.e., sandwiched between) the bowl 12 and bowl liner 22 and relative motion between the liner and bowl in at least a first rotational direction about the central axis (i.e., either clockwise or counter-clockwise) is prevented. The wedges 30 are placed into the rotation-preventing position under normal circumstances and during normal operation of the system 100. However, the wedges 30 are periodically moved to the rotation-permitting position, including when maintenance is to be performed to the system 100 such as when the bowl liner 22 is being replaced. When the wedge 30 is in the rotation-permitting position, it is not in simultaneous abutment with the bowl 12 and bowl liner 22 and at least some relative rotational motion between the bowl liner and bowl is permitted. More particularly, in many cases, when the wedge 30 is in the rotation-permitting position at least one of the following conditions is present, either (i) the surface 32 of lug 28 does not abut corresponding surface 34 of wedge 30, (ii) surface 74 of spacer 38 does not abut corresponding surface 76 of the wedge.

As illustrated in FIG. 5, the spacers 38 may be incorporated into the bowl 12 casting, separately attached after the casting is complete, or replaced entirely by other components that serve to properly locate the wedges 30. In this case, the spacer 38 is formed as a single continuous ring that has been welded into the bowl 12, with gap area 36 and the surfaces 74 created by removing a portion of the ring that is suitably sized for the selected wedges 30 and lug 28.

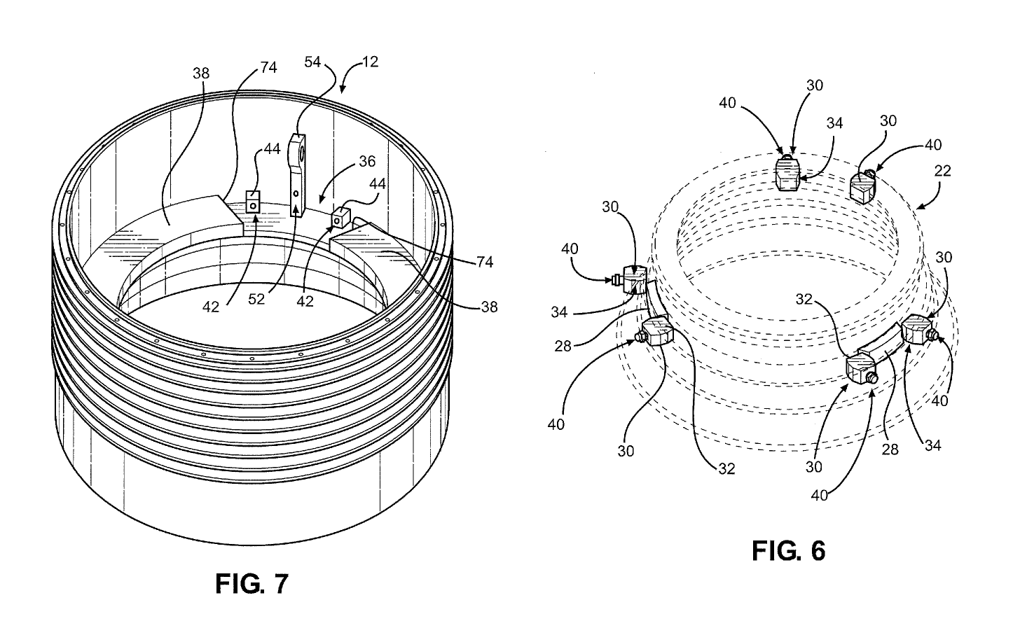

Each wedge may be provided with an actuating means, such as a jack, hydraulic linear actuator, or other (including manually or electronically-controlled) means, for automatically or manually sliding the wedges towards and away from the bowl liner. In this particular case, as shown best in FIGS. 6 and 7, a radially-directed jack screw 40 is aligned with and is adapted to engage hole 42 in a retaining block 44 mounted on the bowl 12. The retaining blocks 44 need not be mounted to the bowl, so long as they are adapted to assist in creating a radial force that is applied to the wedges 30 with which they are associated. Other mechanisms known to those having ordinary skill in the art to which the invention relates may be employed to apply a radial force to a wedge.

An important aspect for preventing rotation in most cases is that, in the rotation preventing position, the wedge 30 fills in space in the gap area 36 that is located between the lug and at least one side 74 of the gap area. Also, the interfaces 72, 76 between the lug 28, wedges 30, spacers 38 are tight (i.e., the angles of the various components at these interfaces match the angle of the adjacent component). In the rotation permitting position, the wedges 30 are drawn back from the lug 28 so that the front portion of the gap space 36 is not completely filled. It may be apparent, therefore, that in certain cases the two wedges 30 could be replaced by a single wedge. In that case, one side of the lug 28 could be placed against the surface 74 of the gap area 36 and the single wedge 30 could be located on the opposite side of the lug. The opposite side of the single wedge 30 would be placed against the opposite surface 74 of the gap area 36. This arrangement would completely fill the front of the gap area 36 and would prevent rotation.

It may also be appreciated from the above discussion that the performance of the lug 28 is primarily dependent on the orientation of and spacing between its two side surfaces 32. For that reason, the single lug 28 discussed above can also be replaced by a pair of separate lugs (i.e., a left lug and a right lug) extending from the bowl liner 12 and separated by a fixed amount of space and each having a side surface 32 (i.e., the sides nearest the sides 74 of the gap area 36). By appropriately spacing and orienting those two separate side surfaces 32, the two lugs would function identically as a similar single lug.

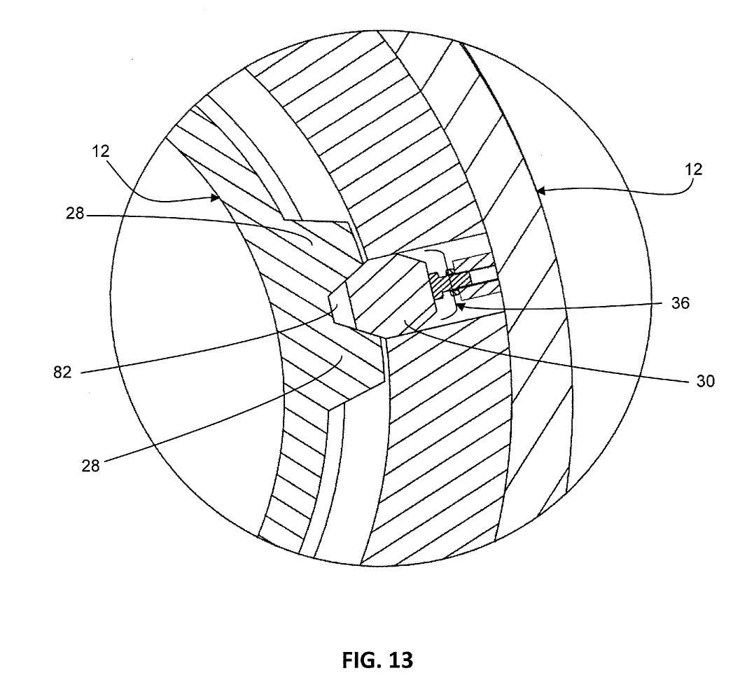

With reference now to FIG. 13, an alternative lug arrangement is provided. In the cases discussed above, the lug 28 was inserted into a gap space 36 formed in the bowl 12 and the wedges 30 were wedged between the sides of that gap space and the lug in order to prevent rotation. The embodiment of FIG. 13 is an inversion of that design because the wedge 30 extends out of gap area 36 into a recessed area 82 formed in the bowl liner 12. In some cases, that recessed area is formed by recessing the exterior of the bowl liner 22, but in the illustrated embodiment the recessed area 82 is formed between two spaced apart lugs 28 that extend outward from the exterior of the bowl liner. An advantage of this design is that it is simpler and requires only a single wedge 30 to prevent rotation.

As discussed above, the presently-disclosed system relies on contact or abutment between the surfaces of the wedge, lug and bowl to transmit a force acting approximately perpendicular to the radius of the bowl liner at the point of abutment to prevent rotation. In addition to rotational movement, it may also be desirable to resist or prevent motion of system components in a vertical direction as well. Accordingly, as depicted in FIGS. 6-12, certain embodiments of the system 100 may include a retaining ring 46 that, among other functions, provides a downwards clamping force onto the wedges 30 to limit vertical movement of the anti-rotation system components.

As shown, a plurality of axially oriented bolts 48, including at least one bolt 48W that is adapted to exert a downward clamping force on wedge 30, are inserted through the retaining ring 46. Preferably, at least one axially-oriented bolt 48W is provided for each wedge 30 and a pair of axially-oriented bolts 48 are spaced between each adjacent pair of wedges 30. It is also preferred that retaining ring 46 be provided with at least one radially directed jack screw 50 that is aligned with and adapted to engage a hole 52 in ring support 54 for use in centering portions of the system and restricting radial motion. Of course, other holding or actuating means known to those of skill in the art could be used in place of bolts 48, 48W and jack screw 50.

In order to assemble the bowl 12 and bowl liner 22 according to a preferred embodiment of the invention, the bowl is set on the bowl liner and approximately centered thereon. The bowl 12 and bowl liner 22 are rotationally oriented such that the lug 28 is approximately centered in the gap area 36 formed by the spacer(s) 38 of the bowl 12. Pairs of wedges 30 are placed onto the inside surface 70 of the bowl 12 such that they rest on the horizontal middle portion 64B. When correctly positioned, one wedge 30 of each pair is located on opposite sides of the lug 28 and adjacent a spacer 38. The wedges 30 may be trimmed to fit, if necessary. Each radially directed jack screw 40 is then threaded into hole 42 in a retaining block 44 mounted on the bowl. Alternatively, other actuating means are mounted to the wedges 30. Optionally, retaining ring 46 is then installed over the bowl 12 and bowl liner 22, and jack screws 50 are threaded into holes 52 in ring supports 54 on the bowl. The axially oriented bolts 48 that are not associated with a wedge 30 are tightened to pull bowl liner 22 into contact or abutment with ring 46. The radially directed jack screws 50 can then be adjusted to center ring 46 with respect to bowl liner 22. Then, bolts 48W are threaded into contact or abutment with wedges 30, and the radially directed jack screws 40 are then tightened against their associated retaining blocks 44. Finally, all of the axially oriented bolts 48 and 48W are tightened.

Although this description contains many specifics, these should not be construed as limiting the scope of the invention but as merely providing illustrations of some of the presently preferred embodiments thereof, as well as the best mode contemplated by the inventor of carrying out the invention. The embodiments of the invention, as described herein, are susceptible to various modifications and adaptations as would be appreciated by those having ordinary skill in the art to which the invention relates.

What is claimed is:

1. A cone crusher apparatus comprising:
a bowl having an inside surface;
a bowl liner having an outside surface and being removably mounted within the bowl along a central axis passing through the bowl and bowl liner such that the outside surface of the bowl liner is substantially adjacent the inside surface of the bowl; and
a wedge that is radially adjustable between the inside surface of the bowl and the outside surface of the bowl liner for moving between a rotation-preventing position and a rotation-permitting position,
wherein, in the rotation-preventing position, the wedge is in simultaneous abutment with the bowl and bowl liner and through that simultaneous abutment immediately develops a maximum holding force such that relative motion between the bowl liner and bowl in a first rotational direction about the central axis is prevented, and
wherein, in the rotation-permitting position, the wedge is not in simultaneous abutment with the bowl and bowl liner and at least some relative motion between the bowl liner and bowl in the first rotational direction about the central axis is permitted.

2. The cone crusher apparatus of claim 1 wherein, when the wedge is in the rotation-preventing position, the bowl liner abuts the wedge along a first upwardly extending liner-wedge interface and the bowl abuts the wedge along a first upwardly extending bowl-wedge interface such that the wedge is sandwiched between the bowl and bowl liner.

3. The cone crusher apparatus of claim 2 further comprising a bowl liner protrusion extending radially outwards from the outside surface of the bowl liner, wherein the first liner-wedge interface is created when the bowl liner protrusion abuts the wedge.

4. The cone crusher apparatus of claim 2 further comprising a bowl protrusion extending radially inwards from the inside surface of the bowl, wherein the first bowl-wedge interface is created when the bowl protrusion abuts the wedge.

5. The cone crusher apparatus of claim 2, wherein the wedge is configured to be radially positioned such that, with relative motion between the bowl liner and bowl in a second rotational direction about the central axis, the bowl liner abuts the wedge along a second liner-wedge interface and the bowl abuts the wedge along a second bowl-wedge interface such that the wedge is sandwiched between the bowl and bowl liner and prevents further relative motion between the bowl liner and bowl in the second rotational direction about the central axis.

6. The cone crusher apparatus of claim 5 further comprising a bowl liner protrusion extending radially outwards from the outside surface of the bowl liner, wherein the first liner-wedge interface is created when the bowl liner protrusion abuts the wedge and wherein the second liner-wedge interface is created when the bowl liner protrusion abuts the wedge.

7. The cone crusher apparatus of claim 5 further comprising a bowl protrusion extending radially inwards from the inside surface of the bowl, wherein the first bowl-wedge interface is created when the bowl protrusion abuts the wedge to prevent relative motion between the bowl liner and bowl in the first rotational direction about the central axis and wherein the second bowl-wedge interface is created when the bowl protrusion abuts the wedge to prevent relative motion between the bowl liner and bowl in the second rotational direction about the central axis.

8. The cone crusher apparatus of claim 7 further comprising a gap area defined by a pair of spaced apart upwardly extending surfaces formed by the bowl protrusion and that extend upwards from the inside surface of the bowl, wherein the wedge is located within the gap area and travels over the inside surface of the bowl when moving radially between the inside surface of the bowl and the outside surface of the bowl liner.

9. The cone crusher apparatus of claim 2 wherein the wedge comprises a first wedge for forming the first liner-wedge interface and the first bowl-wedge interface and a second wedge that is separate and independently radially adjustable from the first wedge for forming the second liner-wedge interface and the second bowl-wedge interface.

10. The cone crusher apparatus of claim 1 further comprising:
a retention ring surrounding a top end of the bowl liner and located above the wedge; and
a plurality of fasteners that pass through the retention ring in a direction parallel to the central axis, including at least one fastener that exerts a force downwards onto the wedge.

11. The cone crusher apparatus of claim 10 further comprising one or more retention ring supports located radially outside the retention ring and having a radially-oriented fastener for exerting a radial force on the retention ring.

12. The cone crusher apparatus of claim 1 wherein the wedge is radially moved between the rotation-preventing position and rotation-permitting position by a hydraulic linear actuator.

13. The cone crusher apparatus of claim 1 wherein the wedge is configured for placement into the apparatus in at least two orientations and to be radially adjustable between the inside surface of the bowl and the outside surface of the bowl liner between a rotation-preventing position and a rotation-permitting position in either of the at least two orientations.

14. The cone crusher apparatus of claim 13 wherein the wedge comprises:
a leading end that, in a first orientation, is in simultaneous abutment with the bowl and bowl liner in the rotation-preventing position; and
a trailing end that is oriented opposite the leading end and that, in a second orientation, is in simultaneous abutment with the bowl and bowl liner in the rotation-preventing position

15. A cone crusher apparatus comprising:
a bowl having an inside surface;
a bowl liner having an outside surface and being removably mounted within the bowl along a central axis passing through the bowl and bowl liner such that the outside surface of the bowl liner is substantially adjacent the inside surface of the bowl;
a recess extending into the outside surface of the bowl liner;
a wedge having a leading end with opposing side surfaces and whose motion is constrained to radial movement between the inside surface of the bowl and the outside surface of the bowl liner for moving between a rotation-preventing position and a rotation-permitting position,
wherein, in the rotation-preventing position, a portion of the wedge is inserted into the recess of the bowl liner such that the opposing side surfaces of the leading end are in simultaneous abutment with the recess such that relative motion between the bowl liner and bowl in a first rotational direction about the central axis is prevented, and
wherein, in the rotation-permitting position, the wedge is not inserted into the recess of the bowl liner and at least some relative motion between the bowl liner and bowl in the first rotational direction about the central axis is permitted.

16. The cone crusher apparatus of claim 15 wherein the recess is formed by a pair of spaced apart liner protrusions extending radially outwards from the outside surface of the bowl liner.

17. A cone crusher apparatus comprising:
a bowl having an inside surface;
a bowl liner having an outside surface and being removably mounted within the bowl along a central axis passing through the bowl and bowl liner such that the outside surface of the bowl liner is substantially adjacent the inside surface of the bowl; and
a wedge that is rotationally fixed with respect to the central axis and that is radially adjustable between (i) a rotation-preventing position, where the wedge abuts the outside surface of the bowl liner and due to that abutment the bowl liner is prevented from rotating with respect to the bowl, and (ii) a rotation-permitting position, where the wedge is disengaged from the bowl liner for permitting rotation of the bowl liner with respect to the bowl.

18. The cone crusher apparatus of claim 17 wherein, in the rotation-preventing position, the wedge abuts the outside surface of the bowl liner at a planar vertical interface.

19. The cone crusher apparatus of claim 17 wherein the wedge has a leading end with opposing side surfaces and wherein, in the rotation-preventing position, each of the opposing side surfaces engage the outside surface of the bowl liner at a planar vertical interface.
